(19) United States
(12) Patent Application Publication
(10) Pub. No.: US 2010/0064841 A1
(43) Pub. Date: Mar. 18, 2010

(54) CONTROL ASSEMBLY FOR ELECTRONIC DEVICE

(75) Inventor: Wen-Ze Liu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/354,092

(22) Filed: Jan. 15, 2009

(30) Foreign Application Priority Data
Sep. 12, 2008 (CN) 200810304492.8

(51) Int. Cl. G05G 1/02

(52) U.S. Cl. 74/503

(57) ABSTRACT

A control assembly for an electronic device includes a housing, a control and a support member. The housing defines a chamber and an opening. The control is received in the opening of the housing. The support member is received in the chamber and resists the control.

### BACKGROUND

1. Technical Field

The present disclosure relates to control assemblies, particularly to a control assembly used in a portable electronic device.

2. Description of related art

Many portable electronic devices, such as mobile phones, utilize a housing with an interior compartment receiving a printed circuit board (PCB). The devices often include a control assembly on one side of the housing, allowing one-handed operation of the device.

Typically, the control assembly is disposed in a space defined in an outer shell of the portable electronic device, with a slight gap defined between the control assembly and the outer shell. The control moves easily in the opening, and may, under more serious agitation, be physically separated therefrom.

Therefore, there is a need for a control assembly addressing the limitations described.

### BRIEF DESCRIPTION OF THE DRAWINGS

Many aspects of the disclosed control assembly can be better understood with reference to the following drawings. The components in the drawings are not necessarily drawn to scale, the emphasis instead being placed upon clearly illustrating the principles of the present control assembly assembly, in which:

FIG. 1 is an exploded view of a portion of a portable electronic device using a control assembly in accordance with an exemplary embodiment;

FIG. 2 is similar to FIG. 1, but showing another aspect thereof, and

FIG. 3 is an assembled view of the portable electronic device shown in FIG. 1.

### DETAILED DESCRIPTION OF THE EMBODIMENTS

The disclosed control assembly is applied in portable electronic devices such as a mobile phone or a personal digital assistant (PDA) in accordance with an exemplary embodiment. In the exemplary embodiment, the control assembly controlling volume of the mobile phone is illustrated, although the disclosure is not limited thereto.

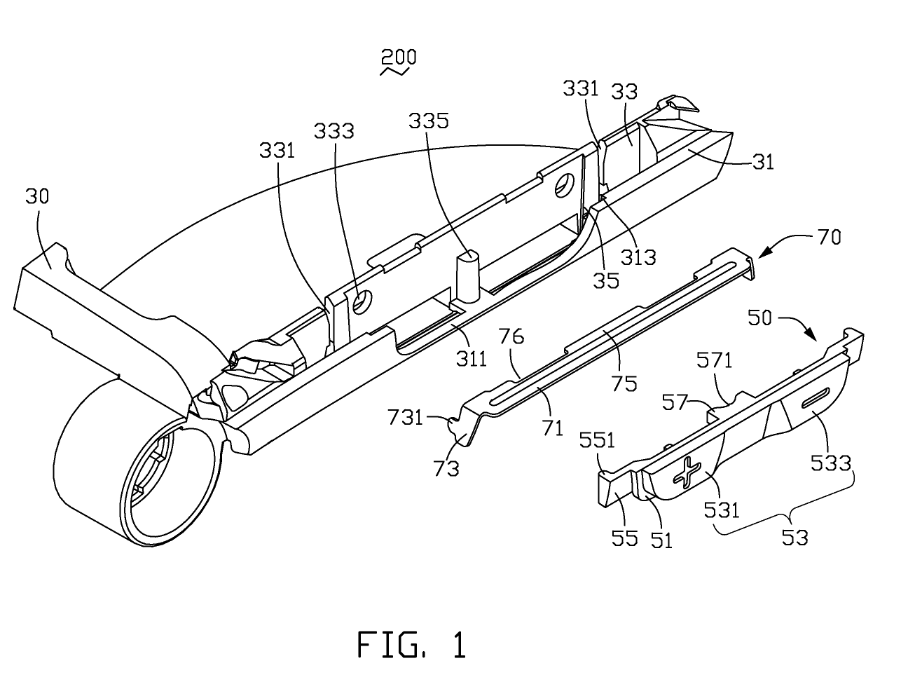

FIG. 1 shows a portable electronic device 200 (only a portion of which is shown) including a housing 30, a control 50, and a support member 70. The support member 70 is mounted in the housing 30, and the control 50 is disposed between the support member 70 and the housing 30.

The housing 30 includes a sidewall 31 and a stopper board 33. Two ends of the stopper board 33 intersect with the sidewall 31. The sidewall 31 and the stopper board 33 cooperatively define a chamber 35. The sidewall 31 defines an opening 311. An internal side of the sidewall 31 is recessed to define a notch 313 communicating with the opening 311. The stopper board 33 symmetrically defines two slots 331. Each slot 331 is substantially L-shaped, respectively including a vertical length 3311 and a horizontal length 3313. Two latching holes 333 are defined between the slots 331. A semi-cylindrical resisting post 335 extends from a middle area of the stopper board 33 toward the sidewall 31.

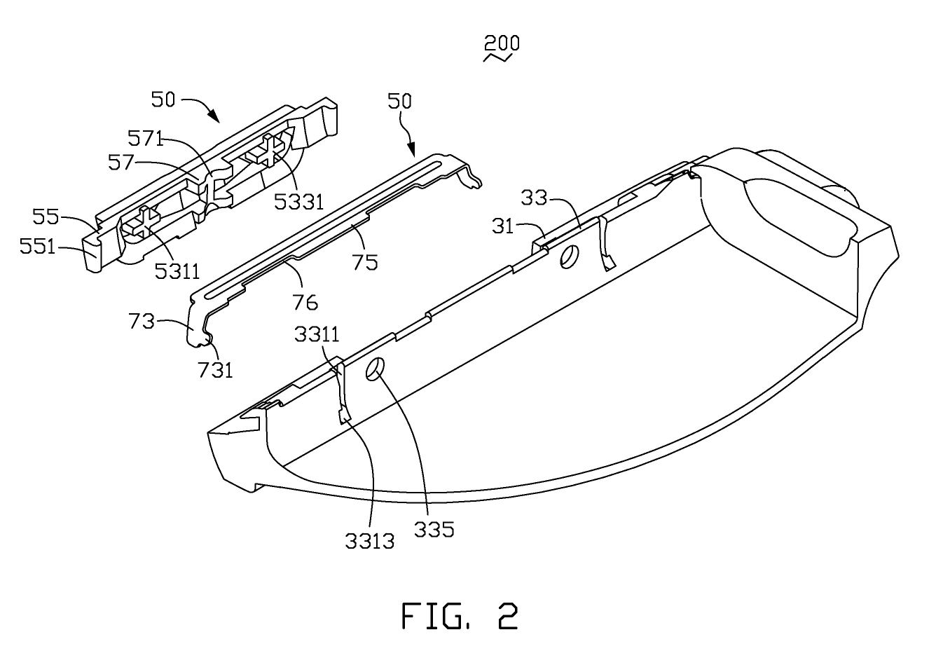

The control 50 includes a main portion 51 and an operating portion 53. The operating portion 53 is integrally formed at one side of the main portion 51. The operating portion 53 includes a first operating portion 531 and a second operating portion 533, separated from each other. The first operating portion 531 is recessed to form a “+” character, and the second operating portion 533 is recessed to form a “−” character. A first protrusion 5311 and a second protrusion 5331 are formed at an opposite side of the main portion 51 corresponding to the first operating portion 531 and the second operating portion 533. Each end of the main portion 51 extends a latching portion 55. Each latching portion 55 includes a projection 551. Referring to FIG. 2, the side of the main portion 51 opposite to the operating portion 53 forms a block 57. The block 57 is substantially I-shaped, and defines an arcuate groove 571 receiving the resisting post 335.

The support member 70 is elastic material such as iron, stainless steel, rubber. The support member 70 includes a base 71 and two extending portions 73 bending from two ends thereof. Each extending portion 73 is angled with the base 71. In an exemplary embodiment, each extending portion 73 is angled with the base 71 by an obtuse angle. An arcuate tab 731 protrudes from each extending portion 73. The base 71 symmetrically defines two cutouts 76. Correspondingly, a middle portion 75 is formed between the two cutouts 76.

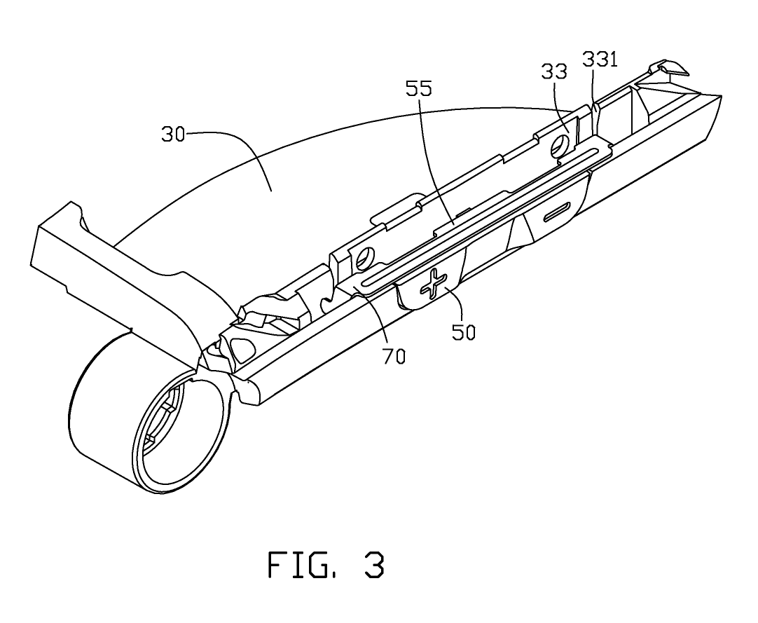

Referring to FIG. 3, during assembly, the control 50 passes through the opening 311 to allow the main portion 51 to be received in the chamber 35. The resisting post 335 is received in the arcuate groove 571. Each extending portion 55 is respectively received in the notch 313, and resists the sidewall 31. The tabs 731 of the support member 70 pass through the vertical length 3311 and are locked in the horizontal length 3313. The base 71 is positioned above the top surface of the control 50. Since the support member 70 is disposed between the control 50 and the housing 30, the control 50 tightly joins the housing 30.

In use, the first operating portion 531 or the second operating portion 533, when pressed, contact the volume circuit board, to, for example, generate an electrical signal. Since the extending portions 55 are latched between the sidewall 31 and the support member 70, and the resisting post 335 are movable in the arcuate groove 571, the operation of control 30 is more stable.

It is to be understood, however, that even through numerous characteristics and advantages of the present disclosure have been set forth in the foregoing description, together with details of assembly and function, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A control assembly for an electronic device, comprising:
a housing defining a chamber and an opening;
a control received in the opening of the housing; and
a support member received in the chamber and resisting the control.

2. The control assembly as claimed in claim 1, wherein the housing includes a sidewall and a stopper board, the chamber being defined between the sidewall and the stopper board.

3. The control assembly as claimed in claim 2, wherein the stopper board defines two slots, in which are correspondingly received two extending portions formed by the support member.

4. The control assembly as claimed in claim 3, wherein a tab protrudes from each extending portion.

5. The control assembly as claimed in claim 1, wherein the support member is iron, stainless steel, or rubber.

6. The control assembly as claimed in claim 2, wherein the stopper board forms a resisting post received in a groove formed by the control.

7. The control assembly as claimed in claim 1, wherein the control includes a main portion on one side of which is formed an operating portion, and on another side of which are formed two latching portions.

8. An electronic device comprising a control assembly for controlling volume of the electronic device, the cover assembly comprising:
a housing defining a chamber and an opening;
a control received in the opening of the housing; and
a support member received in the chamber and resisting the control.

9. The electronic device as claimed in claim 8, wherein the housing includes a sidewall and a stopper board, the chamber being defined between the sidewall and the stopper board, and the stopper board forms a resisting post received in a groove formed by the control.

10. The electronic device as claimed in claim 9, wherein the stopper board defines two slots, in which are correspondingly received two extending portions formed by the support member.

11. The electronic device as claimed in claim 10, wherein a tab protrudes from each extending portion.

12. The electronic device as claimed in claim 8, wherein the support member is iron, stainless steel, or rubber.

13. The electronic device as claimed in claim 8, wherein the control includes a main portion on one side of which is formed an operating portion, and on another side of which are formed two latching portions.
